(19) United States
(12) Patent Application Publication
(10) Pub. No.: US 2021/0266959 A1
(43) Pub. Date: Aug. 26, 2021

(54) SYNCHRONIZED BACKOFF WINDOW

(71) Applicant: QUALCOMM Incorporated, San Diego, CA (US)

(72) Inventors: Maarten Menzo WENTINK, Nijmegen (NL); George CHERIAN, San Diego, CA (US); Lochan VERMA, Danville, CA (US); Aleksandar DAMNJANOVIC, Del Mar, CA (US); Marco PAPALEO, Bologna (IT)

(21) Appl. No.: 17/146,171

(22) Filed: Jan. 11, 2021

Related U.S. Application Data
(60) Provisional application No. 62/979,192, filed on Feb. 20, 2020.
(60) Provisional application No. 62/979,238, filed on Feb. 20, 2020.

(51) Int. Cl. H04W 74/04; H04W 56/00; H04W 72/04

(52) U.S. Cl. CPC H04W 74/04; H04W 72/0446; H04W 56/001

(57) ABSTRACT

This disclosure provides systems, methods, apparatus and wireless nodes as well as computer programs encoded on computer-readable mediums for providing synchronized start times of backoff windows in a given or particular physical area. In some implementations, a schedule of synchronized start times may be determined and an indication that the first schedule is active may be signaled. In some other implementations, signaling indicating a first schedule of synchronized start times is active may be detected and channel access may be performed according to the first schedule.

### CROSS REFERENCE TO RELATED APPLICATION

This application hereby claims priority under 35 U.S.C. § 119 to U.S. Provisional Patent Application No. 62/979,192, filed on Feb. 20, 2020 and U.S. Provisional Patent Application No. 62/979,238, filed on Feb. 20, 2020, the contents of both are incorporated herein in their entirety.

### TECHNICAL FIELD

Certain aspects of the present disclosure generally relate to wireless communications and, more particularly, to techniques for synchronizing backoff window start times.

### BACKGROUND

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (such as tens of meters to a few hundred meters).

### SUMMARY

The systems, methods, and devices of the disclosure each have several aspects, no single one of which is solely responsible for its desirable attributes. Without limiting the scope of this disclosure as expressed by the claims which follow, some features will now be discussed briefly.

Certain aspects provide a method for wireless communications by a first node. The method generally includes determining a first schedule of synchronized start times, where the first schedule is determined based on a periodicity of the synchronized start times, and signaling an indication that the first schedule is active.

Certain aspects provide a method for wireless communications by a first node. The method generally includes detecting signaling indicating a first schedule of synchronized start times is active, performing channel access according to the first schedule, and providing, for transmission, a demarcation signal indicating the first schedule is active.

Certain aspects provide an apparatus for wireless communications by a first node. The apparatus generally includes means for determining a first schedule of synchronized start times, where the first schedule is determined based on a periodicity of the synchronized start times, and means for signaling an indication that the first schedule is active.

Certain aspects provide an apparatus for wireless communications by a first node. The apparatus generally includes means for detecting signaling indicating a first schedule of synchronized start times is active, means for performing channel access according to the first schedule, and means for providing, for transmission, a demarcation signal indicating the first schedule is active.

Certain aspects provide an apparatus for wireless communications by a first node. The apparatus generally includes a processing system that determines a first schedule of synchronized start times, where the first schedule is determined based on a periodicity of the synchronized start times, and signals an indication that the first schedule is active.

Certain aspects provide an apparatus for wireless communications by a first node. The apparatus generally includes a processing system that detects signaling indicating a first schedule of synchronized start times is active, performs channel access according to the first schedule, and provides, for transmission, a demarcation signal indicating the first schedule is active.

Certain aspects provide a wireless node. The wireless node generally includes at least one antenna and a processing system that determines a first schedule of synchronized start times, where the first schedule is determined based on a periodicity of the synchronized start times, and signals, via the at least one antenna, an indication that the first schedule is active.

Certain aspects provide a wireless node. The wireless node generally includes at least one antenna and a processing system that detects, via the at least one antenna, signaling indicating a first schedule of synchronized start times is active, performs channel access according to the first schedule, and provides, for transmission, a demarcation signal indicating the first schedule is active.

Certain aspects provide a computer-readable medium for wireless communications. The computer-readable medium generally includes codes that are executable to determine a first schedule of synchronized start times, where the first schedule is determined based on a periodicity of the synchronized start times, and signal an indication that the first schedule is active.

Certain aspects provide a computer-readable medium for wireless communications. The computer-readable medium generally includes codes that are executable to detect signaling indicating a first schedule of synchronized start times is active, perform channel access according to the first schedule, and provide, for transmission, a demarcation signal indicating the first schedule is active.

Aspects of the present disclosure provide wireless nodes, means for, apparatuses, processors, and computer-readable mediums for performing the methods described herein.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 is a diagram illustrating an example exposed node scenario.

FIG. 4 is a diagram illustrating example channel access delays for an exposed node scenario.

FIG. 5 illustrates example operations for wireless communication, in accordance with certain aspects of the present disclosure.

FIG. 6 illustrates example operations for wireless communication, in accordance with certain aspects of the present disclosure.

FIG. 7 illustrates example backoff window synchronization, in accordance with certain aspects of the present disclosure.

FIG. 8 is a diagram illustrating example channel access delays for an exposed node scenario with backoff window synchronization, in accordance with certain aspects of the present disclosure.

FIG. 9 illustrates an example communications device that may include various components configured to perform operations for the techniques disclosed herein in accordance with aspects of the present disclosure.

FIG. 10 illustrates an example communications device that may include various components configured to perform operations for the techniques disclosed herein in accordance with aspects of the present disclosure.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

An exposed node is a node such as a Node B that is located between two nodes (i.e., Node A and Node C) that are unable to hear each other. Hence, a transmission by Node A does not cause a backoff to be initiated by Node C, and vice versa. If Node C were to detect a particular amount of energy on the medium due to the transmission by Node A, Node C would perform a backoff for a period of time by temporarily waiting to access the medium after the medium transitions from busy to idle. As a result, the exposed Node B may observe a busy medium for long periods of time when each of the adjacent Nodes A and C transmit independently (and without synchronization), causing the exposed Node B to experience excessive backoffs or access delays.

Various implementations or aspects generally relate to wireless nodes that are operable in, at least, unlicensed spectrum. The described techniques may help address the exposed node issue by providing synchronized start times of backoff windows in a given or particular physical area. More specifically, a schedule of synchronized start times may be determined and an indication that the first schedule is active may be signaled. As will be described herein, the synchronized start times may help ensure that exposed nodes will see an idle wireless medium once they start contending and, therefore, will have more of an equal opportunity to access the wireless medium based on their random backoff.

Particular implementations of the subject matter described in this disclosure can be implemented to realize one or more of the following potential advantages. In some implementations, the described techniques can be used to alleviate access delay times when a first node may determine a schedule of synchronized start times by determining a periodicity of the synchronized start times based on a geographic domain. In other words, the periodicity is determined locally by the first node. In some other implementations, the first node may determine the first schedule by obtaining a periodicity of the synchronized start times that had been determined based on a geographic domain. In other words, the periodicity was determined by another node that then provided it to the first node.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The acronyms listed below may be used herein, consistent with commonly recognized usages in the field of wireless communications. Other acronyms may also be used herein, and if not defined in the list below, are defined where first appearing herein.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (such as implemented within or performed by) a variety of wired or wireless apparatuses (such as nodes). In some aspects, a wireless node implemented in accordance with the teachings herein may include an access point or an access terminal.

An access point (“AP”) may include, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may include, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may include a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (such as a cellular phone or smart phone), a computer (such as a laptop), a tablet, a portable communication device, a portable computing device (such as a personal data assistant), an entertainment device (such as a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (such as a wide area network such as the Internet or a cellular network) via a wired or wireless communication link.

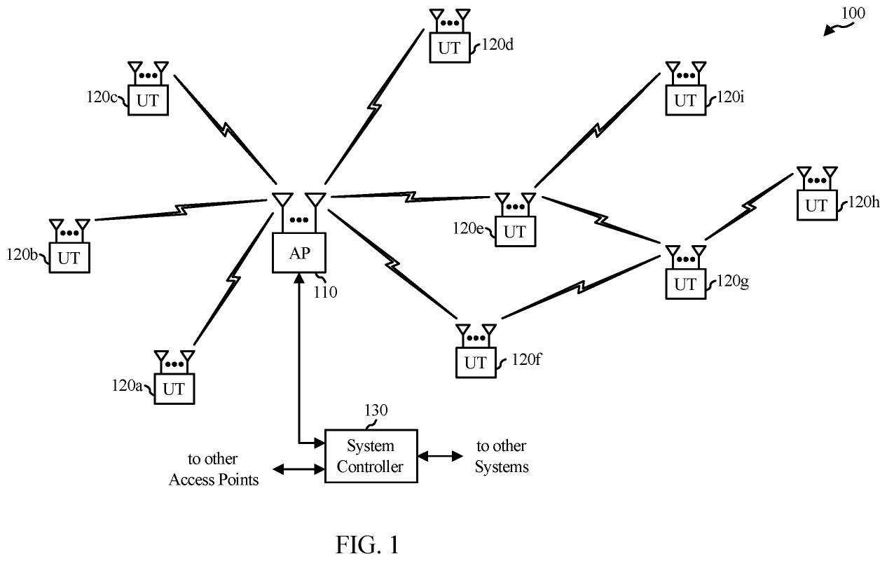

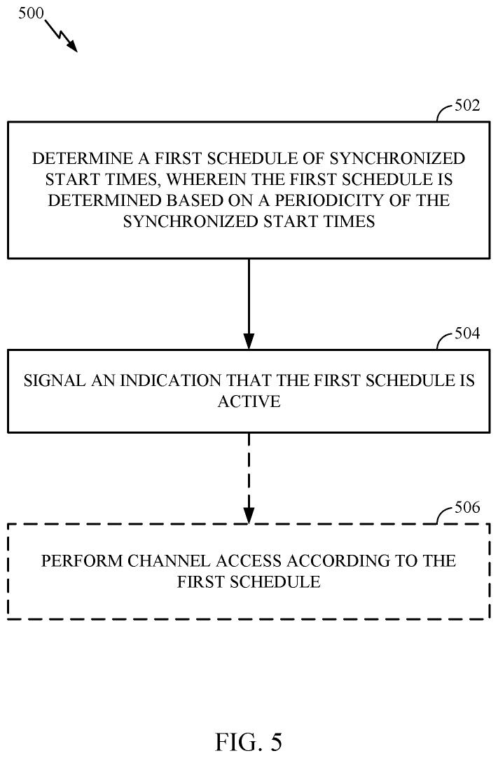

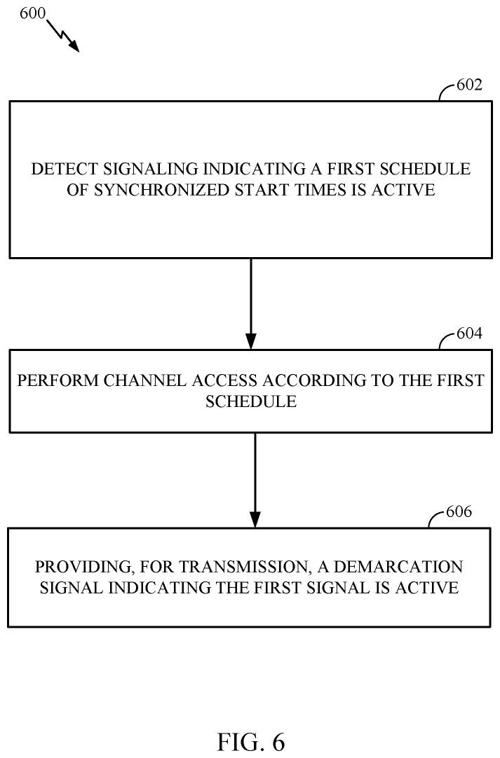

FIG. 1 illustrates a multiple-access multiple-input multiple-output (MIMO) system 100 in which aspects of the present disclosure may be practiced. For example, one or more access points 110 or user terminals 120 may be configured to perform clear channel access (CCA) with synchronized backoff windows in accordance with operations 500 of FIG. 5 or operations 600 of FIG. 6.

For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer or future user terminals being implemented with technology such as SDMA, OFDM or OFDMA to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≤K≤1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to or receives user-specific data from the access point. In general, each selected user terminal may be equipped with one or multiple antennas (i.e., Nᵤₜ≥1). The K selected user terminals can have the same or different number of antennas.

The SDMA system may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (such as in order to keep costs down) or multiple antennas (such as where the additional cost can be supported). The system 100 may also be a TDMA system if the user terminals 120 share the same frequency channel by dividing transmission/reception into different time slots, each time slot being assigned to different user terminal 120.

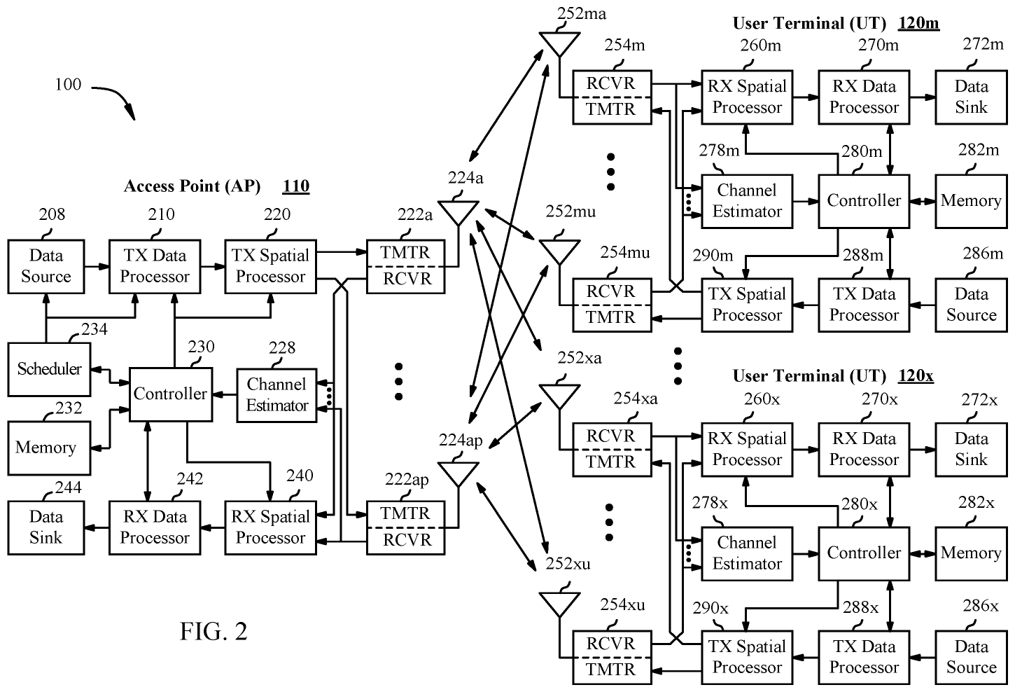

FIG. 2 illustrates a block diagram of access point 110 and two user terminals 120m and 120x in MIMO system 100. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal such as UT 120m selected for uplink transmission, a transmit (TX) data processor 288m receives traffic data from a data source 286m and control data from a controller 280m. TX data processor 288m processes (such as encodes, interleaves, and modulates) the traffic data for the user terminal based on the coding and modulation schemes associated with the rate selected for the user terminal and provides a data symbol stream. A TX spatial processor 290m performs spatial processing on the data symbol stream and provides N_{ut,m} transmit symbol streams for the N_{ut,m} antennas. Each transmitter unit (TMTR) such as TMTR 254m receives and processes (such as converts to analog, amplifies, filters, and frequency upconverts) a respective transmit symbol stream to generate an uplink signal. N_{ut,m} transmitter units 254m through 254mu provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna such as antenna 224a provides a received signal to a respective receiver unit (RCVR) such as RCVR 222a. For example, the receiver unit 222a performs processing complementary to that performed by transmitter unit 254a and provides a received symbol stream. An RX spatial processor 240 performs receiver spatial processing on the Nₐₚ received symbol streams from Nₐₚ receiver units 222a through 222ap and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (such as demodulates, deinterleaves, and decodes) each recovered uplink data symbol stream in accordance with the rate used for that stream to obtain decoded data. The decoded data for each user terminal may be provided to a data sink 244 for storage or a controller 230 for further processing.

On the downlink, at access point 110, a TX data processor 210 receives traffic data from a data source 208 for NA user terminals scheduled for downlink transmission, control data from a controller 230, and possibly other data from a scheduler 234. The various types of data may be sent on different transport channels. TX data processor 210 processes (such as encodes, interleaves, and modulates) the traffic data for each user terminal based on the rate selected for that user terminal. TX data processor 210 provides NA downlink data symbol streams for the NA user terminals. A TX spatial processor 220 performs spatial processing (such as a precoding or beamforming, as described in the present disclosure) on the NA downlink data symbol streams, and provides Nₐₚ transmit symbol streams for the Nₐₚ antennas. Each of the transmitter units 222a through 222ap receives and processes a respective transmit symbol stream to generate a downlink signal. Nₐₚ transmitter units 222a through 222ap provide Nₐₚ downlink signals for transmission from Nₐₚ antennas 224a through 224ap to the user terminals.

At each user terminal 120 such as UT 120m, N_{ut,m} antennas 252ma through mu receive the Nₐₚ downlink signals from access point 110. For example, receiver unit 254m processes a received signal from an associated antenna 252ma and provides a received symbol stream. An RX spatial processor 260m performs receiver spatial processing on N_{ut,m} received symbol streams from N_{ut,m} receiver units 254m through 254mu and provides a recovered downlink data symbol stream for the user terminal. The receiver spatial processing is performed in accordance with the CCMI, MMSE or some other technique. An RX data processor 270m processes (such as demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (such as the downlink or uplink eigenvectors, eigenvalues, SNR estimates, and so on) to the access point. Controllers 230 and 280 also control the operation of various processing units at access point 110 and user terminal 120, respectively.

Distributed channel access (DCA) in unlicensed spectrum is currently based on listen before talk (LBT) with a random backoff time. The general principle is for a transmitting device to first sense a channel (wireless medium) before transmitting. If the device does not sense energy above an energy detection (ED) threshold, the device declares the wireless medium idle and is allowed to transmit. On the other hand, if the device senses energy on the wireless medium above the ED threshold (indicating another device is transmitting), the device declares the wireless medium busy and waits a random backoff time before trying to access the wireless medium again.

This LBT with random backoff time may have issues. For example, in some cases, a node may reside within the coverage area of two nodes that are not within their respective detection areas. Such a node is referred to as an exposed node.

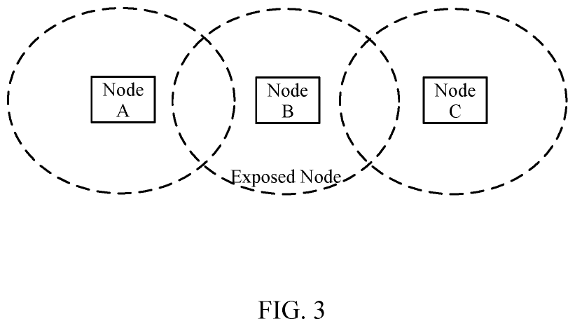

FIG. 3 illustrates an example of an exposed node scenario. As illustrated, the exposed node (Node B) is located between two nodes, Nodes A and Nodes B. Nodes A and B are unable to hear each other and, hence, a transmission does not cause a backoff on the other. As a result, exposed Node B may observe a busy wireless medium for long periods of time when each of the adjacent Nodes A and B transmit independently (and without synchronization), causing the exposed node to experience excessive access delays.

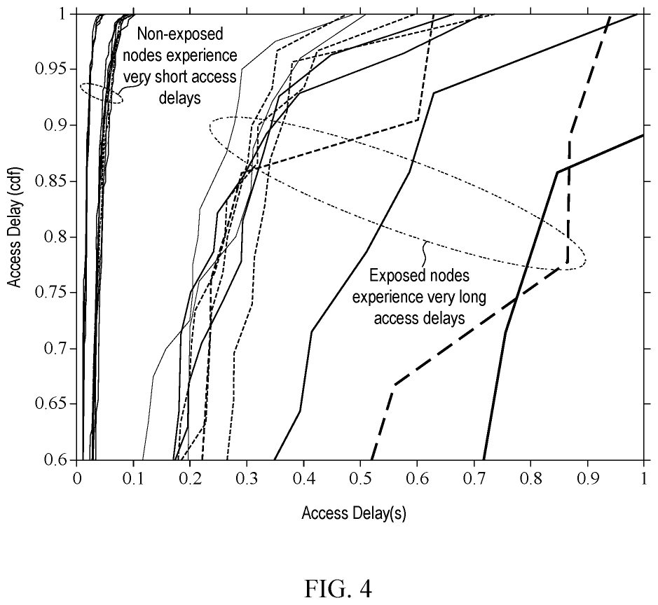

FIG. 4 illustrates the impact of the exposed node problem on access delay times. The example assumes a grid of 5×5 APs, with 3 STAs per AP randomly distributed in the coverage range of each AP. As illustrated, exposed nodes may experience much longer access delays relative to non-exposed nodes. In the example, 95% of the time, non-exposed nodes are able to access the wireless medium in less than 0.05s, while exposed nodes often experience access delay times of 0.2s or higher.

Aspects of the present disclosure may help address the exposed node issue by providing synchronizing the start times of backoff windows in a given physical area. As will be described herein, the synchronized start times may help ensure that exposed nodes will see an idle wireless medium once they start contending and, therefore, will have more of an equal opportunity to access the wireless medium based on their random backoff.

FIG. 5 is a flow diagram illustrating example operations 500 for wireless communication by a first node, in accordance with certain aspects of the present disclosure. The operations 500 may be performed by an apparatus, such as the AP 110 (or UT 120).Operations 500 begin, at 502, by determining a first schedule of synchronized start times, where the first schedule is determined based on a periodicity of the synchronized start times. The synchronized start times may be synchronized backoff start times associated with random access backoff time intervals for nodes to wait before access a channel. Furthermore, the determination of the first schedule includes determining a periodicity of the synchronized start times based on a geographic domain. In other words, the periodicity is determined locally by the first node. Alternatively, the determination of the first schedule includes obtaining a periodicity of the synchronized start times that had been determined based on a geographic domain. In other words, the periodicity was determined another node that then provided it to the first node.

At 504, the first node signals an indication that the first schedule is active. At 506, the first node performs channel access according to the first schedule.

FIG. 6 is a flow diagram illustrating example operations 600 for wireless communication by a first node, in accordance with certain aspects of the present disclosure. The operations 600 may be performed by an apparatus, such as the AP 110 (or UT 120).

Operations 600 begin, at 602, by detecting signaling indicating a first schedule of synchronized start times is active. Again, the scheduled start times may be synchronized backoff start times associated with random access backoff time intervals for nodes to wait before access a channel. At 604, the first node performs channel access according to the first schedule. Thereafter at 606, the first node provides, for transmission, a demarcation signal indicating the first schedule is active.

As indicated above, the synchronized start times may help ensure that exposed nodes will see an idle wireless medium once they start contending and, therefore, may have equal opportunity to access the wireless medium based on their random backoff.

In some cases, the end time of the backoff windows can be synchronized as well. This may not be needed, however, because the expiry of a backoff at a node or a nearby node will implicitly end the backoff window. Once the CCA goes busy or the node starts transmitting, the backoff window is assumed to have ended, and it will continue only at the next scheduled start time.

In some cases, a first node in a given physical domain can start a schedule of its own choosing. In some cases, the first node may use a periodicity that is required by the geographic domain (such as 6 ms).

A subsequent node starting up in the same physical domain may detect that a backoff window start schedule is active in the domain, in which case it copies it. The subsequent node may calibrate its clock to the node that initiated the schedule, or to a node that indicates it is calibrated to the node that started the schedule. Clock calibration can be achieved, for example, by determining the difference between the number of clock ticks over a given period of time between the reference node and the calibrating node. The difference can then be used for a longer period of time, depending on the amount of clock frequency drift at a given node (for example, due to temperature variations at the node). Such clock calibration may be performed relatively infrequently.

In some cases, to indicate that a schedule is active, a node (such as a WiFi node) can include information about the schedule in its beacon (which is typically transmitted 10× per second).

In some cases, to indicate that a schedule is active, a node can transmit a short demarcation signal that ends at the start of the scheduled backoff window. Transmissions from nodes that adhere to the schedule must end before the start of the demarcation signal in this case (rather than before the start of the scheduled backoff window).

The demarcation signal may be transmitted at the same time by all nodes participating in the schedule, so the signal must not include node information specific. In some cases, the demarcation signal may be an agreed upon pattern of energy bursts, also referred to as On-Off Keying (OOK). In other cases, the demarcation signal may be coded differently.

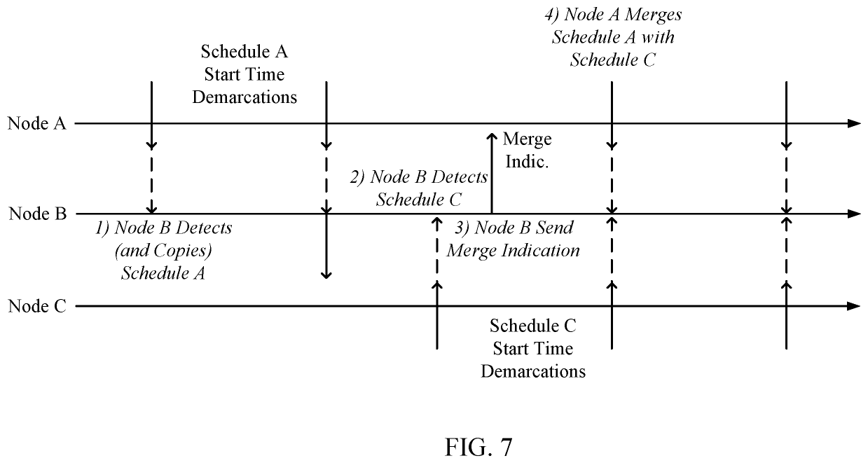

FIG. 7 illustrates an example of synchronized backoff start windows indicated with demarcation signals. In the illustrated example, Node B (such as an exposed node), detects the start time demarcation signal for a first schedule (Schedule A) of Node A. As illustrated Node B copies Schedule A and transmits its own start time demarcation signals at the same time as Node A. Such transmissions from Node B may reach nodes that are not able to detect the demarcation signals from Node A.

In some cases, when a node detects that two or more schedules are active around it, the node selects one schedule and informs the other schedule domain(s) to move their schedule. This process may be referred to as merging time domains.

In some cases, a node may detect that multiple schedules are active when it receives demarcation signals that are not spaced apart by a period less than the standardized period. A node that merges time domains may transmit a merge indication signal immediately after the demarcation signal from the time domain that is to be moved.

For example, as illustrated in FIG. 7, upon detecting a demarcation signal from Node C (per Schedule C), Node B may transmit a merge indication to Node A. Upon detecting the merge indication, Node A may merge its schedule (Schedule A) with Schedule C.

In some cases, a node that merges time domains may transmit a demarcation signal at the time of the schedule that it selected to use. In some cases, the time domain to join may be based on the received signal strength of the demarcation signal.

In some cases, the merge indication signal may be sent via OOK. In other cases, the merge indication signal may also be coded differently. The merge indication signal may be a single energy burst transmitted immediately after the demarcation signal of the schedule that needs to be moved.

In some cases, a node that receives a merge indication signal immediately after transmitting its demarcation signal may postpone the start of its backoff window until it receives a demarcation signal without a subsequent merge indication signal. Implicitly, the merge indication signal may effectively invalidate an active schedule by causing a CCA busy condition immediately after the start of a scheduled backoff window.)

In some cases, the time immediately after the demarcation signal may be reserved for the merge indication signal. In some cases, two time domains may also coalesce when they are physically moved together or when a physical barrier is removed between them.

When two time domains coalesce, for one of the time domains, the wireless medium will not be idle immediately after its demarcation signal. The absence of a transmission in this case may allow receipt the demarcation signal of the other time domain, which will serve as an indication that multiple schedules are active in the same physical domain. As described above, a node that detects that multiple schedules are active may cause a move to the new schedule by transmitting a merge indication signal before the start of the current scheduled backoff window, before moving to the new schedule.

In some cases, a wireless medium busy condition immediately following the transmission by a node of its demarcation signal may be used as an implicit indication that another schedule is active, assuming that all nodes in a given band use scheduled backoff window operation. The schedule may be merged to the next received demarcation signal in this case.

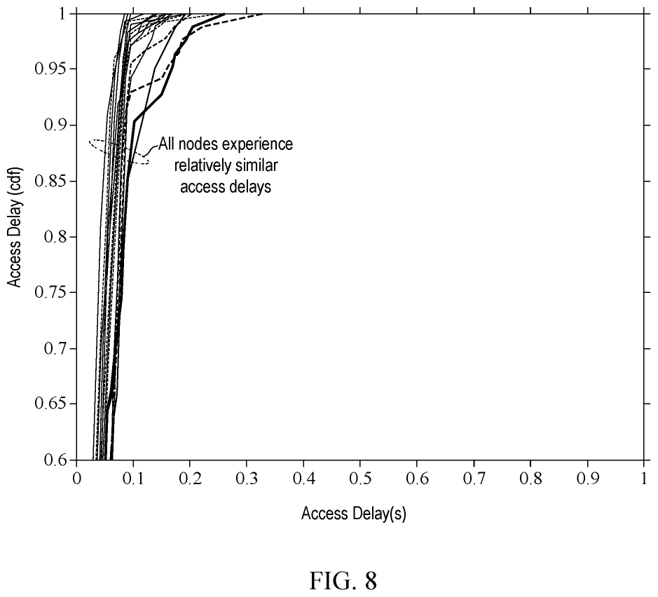

FIG. 8 illustrates how the techniques presented herein may help alleviate the impact of the exposed node problem on access delay times, using the same assumptions as FIG. 4 (such as 5×5 APs, with 3 STAs per AP randomly distributed in the coverage range of each AP). As illustrated in FIG. 8, all nodes experience relatively similar access delays. While the non-exposed nodes may experience slightly higher access delays, when compared to FIG. 4, the access delays of the exposed nodes are significantly reduced.

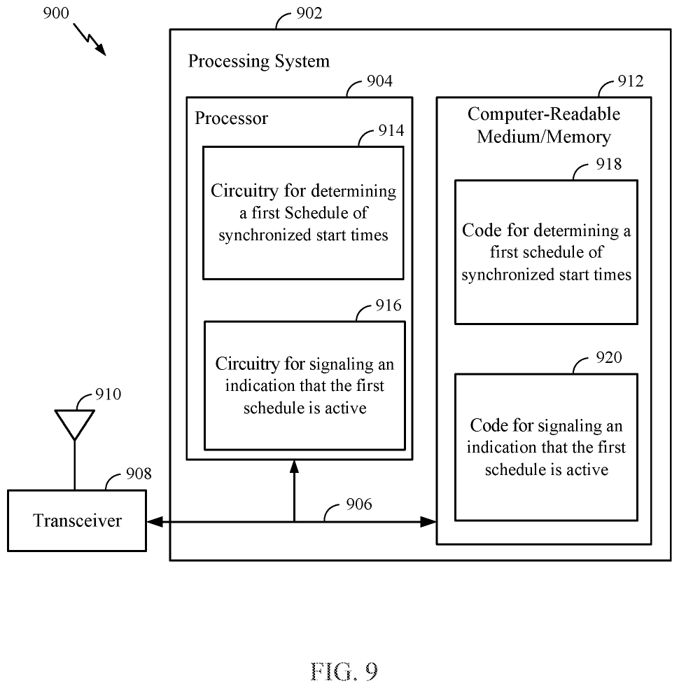

FIG. 9 illustrates an example communications device 900 such as a wireless node that may include various components configured to perform operations for the techniques disclosed herein, such as the operations illustrated in FIG. 5. The communications device 900 includes a processing system 902 coupled to a transceiver 908. The transceiver 908 is configured to transmit and receive signals for the communications device 900 via an antenna 910, such as the various signals as described herein. The processing system 902 may be configured to perform processing functions for the communications device 900, including processing signals received or to be transmitted by the communications device 900. The various components of the communications device 900 can be implemented as means-plus-function components.

The processing system 902 includes a processor 904 coupled to a computer-readable medium/memory 912 via a bus 906. In some aspects, the computer-readable medium/memory 912 is configured to store instructions (such as computer-executable code) that when executed by the processor 904, cause the processor 904 to perform the operations illustrated in FIG. 5, or other operations for performing the various techniques discussed herein. In some aspects, computer-readable medium/memory 912 stores code 918 for determining a first schedule of synchronized start times and code 920 for signaling an indication that the first schedule is active. In certain aspects, the processor 904 has circuitry configured to implement the code stored in the computer-readable medium/memory 912. The processor 904 includes circuitry 914 for determining a first schedule of synchronized start times and circuitry 916 for signaling an indication that the first schedule is active.

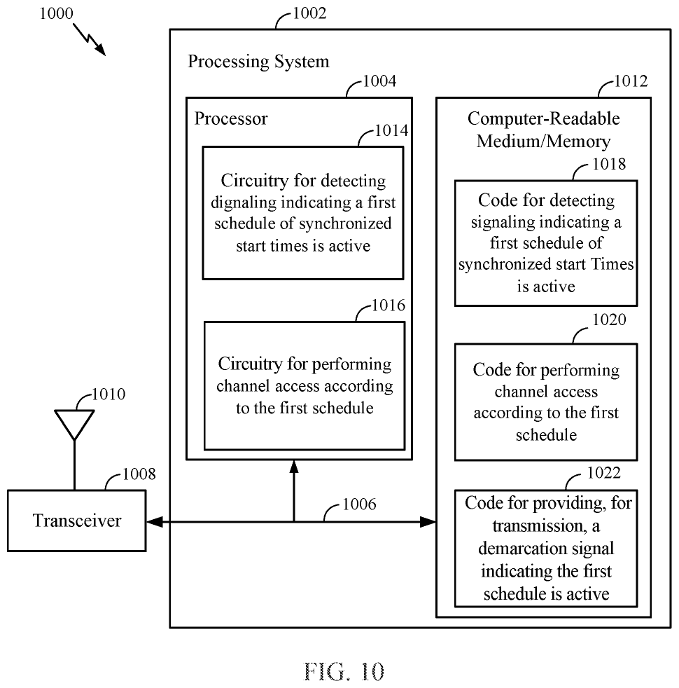

FIG. 10 illustrates an example communications device 1000 such as a wireless node that may include various components configured to perform operations for the techniques disclosed herein, such as the operations illustrated in FIG. 6. The communications device 1000 includes a processing system 1002 coupled to a transceiver 1008. The transceiver 1008 is configured to transmit and receive signals for the communications device 1000 via an antenna 1010, such as the various signals as described herein. The processing system 1002 may be configured to perform processing functions for the communications device 1000, including processing signals received or to be transmitted by the communications device 1000. The various components of the communications device 1000 can be implemented as means-plus-function components.

The processing system 1002 includes a processor 1004 coupled to a computer-readable medium/memory 1012 via a bus 1006. In some aspects, the computer-readable medium/memory 1012 is configured to store instructions (such as computer-executable code) that when executed by the processor 1004, cause the processor 1004 to perform the operations illustrated in FIG. 6, or other operations for performing the various techniques discussed herein. In some aspects, computer-readable medium/memory 1012 stores code 1018 for detecting signaling indicating a first schedule of synchronized start times is active, code 1020 for performing channel access according to the first schedule, and code 1022 for providing, for transmission, a demarcation signal indicating the first schedule is active. In some aspects, the processor 1004 has circuitry configured to implement the code stored in the computer-readable medium/memory 1012. The processor 1004 includes circuitry 1014 for detecting signaling indicating a first schedule of synchronized start times is active and circuitry 1016 for performing channel access according to the first schedule.

In addition to the various aspects described above, aspects of specific combinations are within the scope of the disclosure, some of which are detailed below:

Aspect 1: A method for wireless communications by a first node, including: determining a first schedule of synchronized start times; and signaling an indication that the first schedule is active, where the first schedule is determined based on a periodicity of the synchronized start times.

Aspect 2: The method of Aspect 1, where the synchronized start times are synchronized backoff start times associated with random backoff time intervals for nodes to wait before accessing a channel, the method further including: performing channel access according to the synchronized backoff start times.

Aspect 3: The method of any of Aspects 1-2, where the determination of the first schedule includes determining a periodicity of the synchronized start times based on a geographic domain.

Aspect 4: The method of any of Aspects 1-3, where the determination of the first schedule includes obtaining a periodicity of the synchronized start times that had been determined based on a geographic domain.

Aspect 5: The method of any of Aspects 1-4, where the signaling includes a beacon that includes information about the first schedule.

Aspect 6: The method of any of Aspects 1-5, where the signaling includes a demarcation signal that indicates a start of a backoff window according to the first schedule.

Aspect 7: The method of Aspect 6, where the demarcation signal lacks information specific to the first node.

Aspect 8: The method of Aspect 6, where the demarcation signal includes a pattern of energy boosts.

Aspect 9: The method of any of Aspects 1-8, further including: determining, based on detected signaling, that a second schedule of synchronized start times associated with random backoff time intervals is active; and deciding to merge the first schedule with the second schedule.

Aspect 10: The method of Aspect 9, further including: signaling an indication that the second schedule is active, where the indication that the second schedule is active is signaled via a merge indication signal being transmitted after a transmission of a demarcation signal indicating a start of a backoff window according to the first schedule or where the indication that the second schedule is active is signaled via a demarcation signal indicating a start of a backoff window according to the second schedule.

Aspect 11: The method of Aspect 10, where the merge indication signal includes: a pattern of energy boosts; or a single energy boost.

Aspect 12: The method of Aspect 9, where the detected signaling includes a demarcation signal transmitted from a second node.

Aspect 13: The method of Aspect 9, where the determination that the second schedule is active is based on a channel busy condition occurring after a transmission of a demarcation signal that indicates a start of a backoff window according to the first schedule.

Aspect 14: A method for wireless communications by a first node, including: detecting signaling indicating a first schedule of synchronized start times is active; performing channel access according to the first schedule; and providing, for transmission, a demarcation signal indicating the first schedule is active.

Aspect 15: The method of Aspect 14, where the synchronized start times are synchronized backoff start times associated with random backoff time intervals for nodes to wait before accessing a channel.

Aspect 16: The method of any of Aspects 14-15, further including calibrating an internal clock of the first node based on the first schedule.

Aspect 17: The method of any of Aspects 14-16, where the signaling includes a beacon, sent by a second node, that includes information about the first schedule.

Aspect 18: The method of any of Aspects 14-17, where the signaling includes a demarcation signal that indicates a start of a backoff window according to the first schedule.

Aspect 19: The method of any of Aspects 14-18, where the demarcation signal includes a pattern of energy boosts.

Aspect 20: The method of any of Aspects 14-19, further including: determining, based on additional detected signaling, that a second schedule of synchronized start times associated with random backoff time intervals is active; deciding to follow the second schedule; and signaling to a second node to merge the first schedule with the second schedule.

Aspect 21: The method of Aspect 20, where the signaling to the second node includes a merge indication signal transmitted after a transmission of a demarcation signal indicating a start of a backoff window according to the first schedule.

Aspect 22: The method of Aspect 21, where the merge indication signal includes: a pattern of energy boosts; or a single energy boost.

Aspect 23: The method of Aspect 20, where the decision to follow the second schedule is based on received signal strength of a first demarcation signal that indicates a start of a backoff window according to the first schedule relative to a second demarcation signal that indicates a start of a backoff window according to the second schedule.

Aspect 24: The method of Aspect 20, where the additional detected signaling includes a demarcation signal transmitted from the second node.

Aspect 25: The method of Aspect 20, further including: determining that the second schedule is active based on a channel busy condition occurred after a transmission of a demarcation signal that indicates a start of a backoff window according to the first schedule.

Aspect 26: An apparatus for wireless communications by a first node, including: means for determining a first schedule of synchronized start times, where the first schedule is determined based on a periodicity of the synchronized start times; and means for signaling an indication that the first schedule is active.

Aspect 27: The apparatus of Aspect 26, where the synchronized start times are synchronized backoff start times associated with random backoff time intervals for nodes to wait before accessing a channel, the apparatus further including: means for performing channel access according to the synchronized backoff start times.

Aspect 28: The apparatus of any of Aspects 26-27, where the means for determining the first schedule includes means for determining a periodicity of the synchronized start times based on a geographic domain.

Aspect 29: The apparatus of Aspect 28, where the means for determining the first schedule includes means for obtaining a periodicity of the synchronized start times that had been determined based on a geographic domain.

Aspect 30: The apparatus of any of Aspects 26-29, where the signaling includes a beacon that includes information about the first schedule.

Aspect 31: The apparatus of any of Aspects 26-30, where the signaling includes a demarcation signal that indicates a start of a backoff window according to the first schedule.

Aspect 32: The apparatus of Aspect 31, where the demarcation signal lacks information specific to the first node.

Aspect 33: The apparatus of Aspect 31, where the demarcation signal includes a pattern of energy boosts.

Aspect 34: The apparatus of any of Aspects 26-33, further including: means for determining, based on detected signaling, that a second schedule for synchronized start times associated with random backoff time intervals is active; and means for deciding to merge the first schedule with the second schedule.

Aspect 35: The apparatus of Aspect 34, further including: means for signaling an indication that the second schedule is active, where the indication that the second schedule is active is signaled via a merge indication signal being transmitted after a transmission of a demarcation signal indicating a start of a backoff window according to the first schedule, or where the indication that the second schedule is active is signaled via a demarcation signal indicating a start of a backoff window according to the second schedule.

Aspect 36: The apparatus of Aspect 35, where the merge indication signal includes: a pattern of energy boosts; or a single energy boost.

Aspect 37: The apparatus of Aspect 34, where the detected signaling includes a demarcation signal transmitted from a second node.

Aspect 38: The apparatus of Aspect 34, where the determination that the second schedule is active is based on a channel busy condition occurring after a transmission of a demarcation signal that indicates a start of a backoff window according to the first schedule.

Aspect 39: An apparatus for wireless communications by a first node, including: means for detecting signaling indicating a first schedule of synchronized start times is active; means for performing channel access according to the first schedule; and means for providing, for transmission, a demarcation signal indicating the first schedule is active.

Aspect 40: The apparatus of Aspect 39, where the synchronized start times are synchronized backoff start times associated with random backoff time intervals for nodes to wait before accessing a channel.

Aspect 41: The apparatus of any of Aspects 39-40, further including means for calibrating an internal clock of the first node based on the first schedule.

Aspect 42: The apparatus of any of Aspects 39-41, where the signaling includes a beacon, sent by a second node, that includes information about the first schedule.

Aspect 43: The apparatus of any of Aspects 39-42, where the signaling includes a demarcation signal that indicates a start of a backoff window according to the first schedule.

Aspect 44: The apparatus of any of Aspects 39-43, where the demarcation signal includes a pattern of energy boosts.

Aspect 45: The apparatus of any of Aspects 39-44, further including: means for determining, based on additional detected signaling, that a second schedule for synchronized start times associated with random backoff time intervals is active; means for deciding to follow the second schedule; and means for signaling to a second node to merge the first schedule with the second schedule.

Aspect 46: The apparatus of Aspect 45, where the signaling to the second node includes a merge indication signal transmitted after a transmission of a demarcation signal indicating a start of a backoff window according to the first schedule.

Aspect 47: The apparatus of Aspect 46, where the merge indication signal includes: a pattern of energy boosts; or a single energy boost.

Aspect 48: The apparatus of Aspect 45, where the decision to follow the second schedule is based on received signal strength of a first demarcation signal that indicates a start of a backoff window according to the first schedule relative to a second demarcation signal that indicates a start of a backoff window according to the second schedule.

Aspect 49: The apparatus of Aspect 45, where the additional detected signaling includes a demarcation signal transmitted from the second node.

Aspect 50: The apparatus of Aspect 45, further including: means for determining that the second schedule is active based on a channel busy condition occurred after a transmission of a demarcation signal that indicates a start of a backoff window according to the first schedule.

Aspect 51: An apparatus for wireless communications by a first node, including: a processing system configured to determine a first schedule of synchronized start times, where the first schedule is determined based on a periodicity of the synchronized start times, and signal an indication that the first schedule is active.

Aspect 52: The apparatus of Aspect 51, where: the synchronized start times are synchronized backoff start times associated with random backoff time intervals for nodes to wait before accessing a channel; and the processing system is further configured to perform channel access according to the synchronized backoff start times.

Aspect 53: The apparatus of any of Aspects 51-52, where the determination of the first schedule includes determining a periodicity of the synchronized start times based on a geographic domain.

Aspect 54: The apparatus of Aspect 53, where the determination of the first schedule includes obtaining a periodicity of the synchronized start times that had been determined based on a geographic domain.

Aspect 55: The apparatus of any of Aspects 51-54, where the signaling includes a beacon that includes information about the first schedule.

Aspect 56: The apparatus of any of Aspects 51-55, where the signaling includes a demarcation signal that indicates a start of a backoff window according to the first schedule.

Aspect 57: The apparatus of Aspect 56, where the demarcation signal lacks information specific to the first node.

Aspect 58: The apparatus of Aspect 56, where the demarcation signal includes a pattern of energy boosts.

Aspect 59: The apparatus of any of Aspects 51-58, where the processing system is further configured to: determine, based on detected signaling, that a second schedule for synchronized start times associated with random backoff time intervals is active; and decide to merge the first schedule with the second schedule.

Aspect 60: The apparatus of Aspect 59, where the processing system is further configured to signal an indication that the second schedule is active, where: the indication that the second schedule is active is signaled via a merge indication signal being transmitted after a transmission of a demarcation signal indicating a start of a backoff window according to the first schedule; or the indication that the second schedule is active is signaled via a demarcation signal indicating a start of a backoff window according to the second schedule.

Aspect 61: The apparatus of Aspect 60, where the merge indication signal includes: a pattern of energy boosts; or a single energy boost.

Aspect 62: The apparatus of Aspect 59, where the detected signaling includes a demarcation signal transmitted from a second node.

Aspect 63: The apparatus of Aspect 59, where the determination that the second schedule is active is based on a channel busy condition occurring after a transmission of a demarcation signal that indicates a start of a backoff window according to the first schedule.

Aspect 64: An apparatus for wireless communications by a first node, including: a processing system configured to: detect signaling indicating a first schedule of synchronized start times is active; perform channel access according to the first schedule; and provide, for transmission, a demarcation signal indicating the first schedule is active.

Aspect 65: The apparatus of Aspect 64, where the synchronized start times are synchronized backoff start times associated with random backoff time intervals for nodes to wait before accessing a channel.

Aspect 66: The apparatus of any of Aspects 64-65, where the processing system is further configured to calibrate an internal clock of the first node based on the first schedule.

Aspect 67: The apparatus of any of Aspects 64-66, where the signaling includes a beacon, sent by a second node, that includes information about the first schedule.

Aspect 68: The apparatus of any of Aspects 64-67, where the signaling includes a demarcation signal that indicates a start of a backoff window according to the first schedule.

Aspect 69: The apparatus of any of Aspects 64-68, where the demarcation signal includes a pattern of energy boosts.

Aspect 70: The apparatus of any of Aspects 64-69, where the processing system is further configured to: determine, based on additional detected signaling, that a second schedule for synchronized start times associated with random backoff time intervals is active; decide to follow the second schedule; and signal to a second node to merge the first schedule with the second schedule.

Aspect 71: The apparatus of Aspect 70, where the signaling to the second node includes a merge indication signal transmitted after a transmission of a demarcation signal indicating a start of a backoff window according to the first schedule.

Aspect 72: The apparatus of Aspect 71, where the merge indication signal includes: a pattern of energy boosts; or a single energy boost.

Aspect 73: The apparatus of Aspect 70, where the decision to follow the second schedule is based on received signal strength of a first demarcation signal that indicates a start of a backoff window according to the first schedule relative to a second demarcation signal that indicates a start of a backoff window according to the second schedule.

Aspect 74: The apparatus of Aspect 70, where the additional detected signaling includes a demarcation signal transmitted from the second node.

Aspect 75: The apparatus of Aspect 70, where the processing system is further configured to: determine that the second schedule is active based on a channel busy condition occurred after a transmission of a demarcation signal that indicates a start of a backoff window according to the first schedule.

Aspect 76: A wireless node, including: at least one antenna; and a processing system configured to determine a first schedule of synchronized start times, and signal, via the at least one antenna, an indication that the first schedule is active, where the first schedule is determined based on a periodicity of the synchronized start times.

Aspect 77: A wireless node, including: at least one antenna; and a processing system configured to detect, via the at least one antenna, signaling indicating a first schedule of synchronized start times is active, and perform channel access according to the first schedule.

Aspect 78: A computer-readable medium including codes for wireless communications, said codes being executable to: determine a first schedule of synchronized start times, and signal an indication that the first schedule is active, where the first schedule is determined based on a periodicity of the synchronized start times.

Aspect 79: A computer-readable medium including codes for wireless communications, said codes being executable to: detect signaling indicating a first schedule of synchronized start times is active; perform channel access according to the first schedule; and provide, for transmission, a demarcation signal indicating the first schedule is active.

The various operations of methods described above may be performed by any suitable means capable of performing the corresponding functions. The means may include various hardware or software component(s) or module(s), including, but not limited to a circuit, an application specific integrated circuit (ASIC), or processor. Generally, where there are operations illustrated in figures, those operations may have corresponding counterpart means-plus-function components with similar numbering.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.

The various operations of methods described above may be performed by any suitable means capable of performing the corresponding functions. The means may include various hardware or software component(s) or module(s), including, but not limited to a circuit, an application specific integrated circuit (ASIC), or processor. For example, processors 260m, 270m, 288m and 290m of the UT 120m or processors 210, 220, 240, and 242 of the AP 110 shown in FIG. 2 may be configured to perform operations 500 of FIG. 5 or operations 600 of FIG. 6.

Means for receiving may include a receiver (such as one or more antennas or receive processors) illustrated in FIG. 2. Means for determining, means for signaling, means for performing, means for deciding, means for detecting and means for calibrating may include a processing system, which may include one or more processors, such as processors 260m, 270m, 288m and 290m of the UT 120m or processors 210, 220, 240, and 242 of the AP 110 shown in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception. In some cases, the interface to output a frame for transmission and the interface to obtain a frame (which may be referred to as first and second interfaces herein) may be the same interface.

As used herein, the term “determining” encompasses a wide variety of actions. For example, “determining” may include calculating, computing, processing, deriving, investigating, looking up (such as looking up in a table, a database or another data structure), ascertaining and the like. Also, “determining” may include receiving (such as receiving information), accessing (such as accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for wireless communications by a first node, comprising:
determining a first schedule of synchronized start times, wherein the first schedule is determined based on a periodicity of the synchronized start times; and
signaling an indication that the first schedule is active.

2. The method of claim 1, wherein the synchronized start times are synchronized backoff start times associated with random backoff time intervals for nodes to wait before accessing a channel, the method further comprising:
performing channel access according to the synchronized backoff start times.

3. The method of claim 1, wherein the determination of the first schedule comprises determining the periodicity of the synchronized start times based on a geographic domain.

4. The method of claim 1, wherein the determination of the first schedule comprises obtaining the periodicity of the synchronized start times that had been determined based on a geographic domain.

5. The method of claim 1, wherein the signaling comprises a beacon that includes information about the first schedule.

6. The method of claim 1, wherein the signaling comprises a demarcation signal that indicates a start of a backoff window according to the first schedule.

7. The method of claim 6, wherein the demarcation signal comprises a pattern of energy boosts.

8. The method of claim 1, further comprising:
determining, based on detected signaling, that a second schedule of synchronized start times associated with random backoff time intervals is active; and
deciding to merge the first schedule with the second schedule.

9. The method of claim 8, further comprising:
signaling an indication that the second schedule is active, wherein:
the indication that the second schedule is active is signaled via a merge indication signal being transmitted after a transmission of a demarcation signal indicating a start of a backoff window according to the first schedule; or
the indication that the second schedule is active is signaled via a demarcation signal indicating a start of a backoff window according to the second schedule.

10. The method of claim 9, wherein the merge indication signal comprises:
a pattern of energy boosts; or
a single energy boost.

11. The method of claim 8, wherein the detected signaling comprises a demarcation signal transmitted from a second node.

12. The method of claim 8, wherein the determination that the second schedule is active is based on a channel busy condition occurring after a transmission of a demarcation signal that indicates a start of a backoff window according to the first schedule.

13. A method for wireless communications by a first node, comprising:
detecting signaling indicating a first schedule of synchronized start times is active;
performing channel access according to the first schedule; and
providing, for transmission, a demarcation signal indicating the first schedule is active.

14. The method of claim 13, wherein the synchronized start times are synchronized backoff start times associated with random backoff time intervals for nodes to wait before accessing a channel.

15. The method of claim 13, further comprising calibrating an internal clock of the first node based on the first schedule.

16. The method of claim 13, wherein the signaling comprises a beacon, sent by a second node, that includes information about the first schedule.

17. The method of claim 13, wherein the signaling comprises a demarcation signal that indicates a start of a backoff window according to the first schedule.

18. The method of claim 13, wherein the demarcation signal comprises a pattern of energy boosts.

19. The method of claim 13, further comprising:
determining, based on additional detected signaling, that a second schedule of synchronized start times associated with random backoff time intervals is active;
deciding to follow the second schedule; and
signaling to a second node to merge the first schedule with the second schedule.

20. The method of claim 19, wherein the signaling to the second node comprises a merge indication signal transmitted after a transmission of a demarcation signal indicating a start of a backoff window according to the first schedule.

21. The method of claim 20, wherein the merge indication signal comprises:
a pattern of energy boosts; or
a single energy boost.

22. The method of claim 19, wherein the decision to follow the second schedule is based on received signal strength of a first demarcation signal that indicates a start of a backoff window according to the first schedule relative to a second demarcation signal that indicates a start of a backoff window according to the second schedule.

23. The method of claim 19, wherein the additional detected signaling comprises a demarcation signal transmitted from the second node.

24. The method of claim 22, further comprising:
determining that the second schedule is active based on a channel busy condition occurred after a transmission of a demarcation signal that indicates a start of a backoff window according to the first schedule.

25. An apparatus for wireless communications by a first node, comprising:
a processing system configured to:
determine a first schedule of synchronized start times, wherein the first schedule is determined based on a periodicity of the synchronized start times; and
signal an indication that the first schedule is active.

26. The apparatus of claim 25, wherein the processing system is further configured to:
determine, based on detected signaling, that a second schedule for synchronized start times associated with random backoff time intervals is active; and
decide to merge the first schedule with the second schedule.

27. The apparatus of claim 26, wherein the processing system is further configured to signal an indication that the second schedule is active:
the indication that the second schedule is active is signaled via a merge indication signal being transmitted after a transmission of a demarcation signal indicating a start of a backoff window according to the first schedule; or
the indication that the second schedule is active is signaled via a demarcation signal indicating a start of a backoff window according to the second schedule.

28. An apparatus for wireless communications by a first node, comprising:
a processing system configured to:
detect signaling indicating a first schedule of synchronized start times is active;
perform channel access according to the first schedule; and
providing, for transmission, a demarcation signal indicating the first schedule is active.

29. The apparatus of claim 28, wherein the signaling comprises a beacon, sent by a second node, that includes information about the first schedule.

30. The apparatus of claim 28, wherein the processing system is further configured to:
determine, based on additional detected signaling, that a second schedule for synchronized start times associated with random backoff time intervals is active; and
decide to follow the second schedule; and
signal to a second node to merge the first schedule with the second schedule.
